(19) United States
(12) Patent Application Publication
(10) Pub. No.: US 2017/0322945 A1
(43) Pub. Date: Nov. 9, 2017

(54) Search Engine Direct Links method and system for assigning and displaying in a communication network system thru a search engine website

(71) Applicant: Hector Martin Rodriguez, San Diego, CA (US)

(72) Inventor: Hector Martin Rodriguez, San Diego, CA (US)

(21) Appl. No.: 15/432,920

(22) Filed: Feb. 15, 2017

Related U.S. Application Data
(60) Provisional application No. 62/295,424, filed on Feb. 15, 2016.

(51) Int. Cl. G06F 17/30

(52) U.S. Cl. CPC G06F 17/3089

(57) ABSTRACT

Search Engine Direct Links method and system for assigning and displaying in a communication network system thru a search engine website. A product or service described with the fewest words is linked to websites that provide this product or service. This system and method links those descriptions to their respective websites and save them in a searchable database. This system and method searches this database to produce a small and precise list of websites linked to those products or services descriptions. This system and method allows current, active and supported websites stand out among thousands and thousands of websites found during a regular search engine search by creating a small and separate search engine direct links list result.

### CROSS-REFERENCE TO RELATED APPLICATIONS

This application claims the benefit of provisional patent application Ser. No. 62/295,424, filed 2016 Feb. 15 by the present inventor.

### BACKGROUND

### Prior Art

The following is a table of some prior art that appears relevant:

| Patent Number | Issue Date | Patentee |
|---|---|---|
| 8,554,775 | 2013 Oct. 8 | Kon, et al. |
| 8,972,412 | 2015 Mar. 3 | Christian, et al. |
| 8,515,941 | 2013 Aug. 20 | Avritch, et al. |
| 8,452,748 | 2013 May 28 | Pugh |
| 8,370,365 | 2013 Feb. 5 | Christian, et al. |
| 8,364,662 | 2013 Jan. 29 | Moyer, et al. |
| 8,312,364 | 2012 Nov. 13 | Rowe, et al. |
| 8,150,716 | 2012 Apr. 3 | Lunsford, et al. |

The number of websites in the internet has increased dramatically to a point that a search engine returns hundreds of thousands if not millions of websites hits for a simple term searched. It is impossible to display all hits and impossible for a user to review all of them. Websites are lost in the immense World Wide Web among thousands of websites with similar products and services, all competing for a place in the search engine result list. With this result list, often the user must review many websites before selecting the adequate website most related the search.

Whether a product, data, news or a service users search in the internet thru a search engine website, Search Engine Direct Links (SEDL) help users get a small number of websites hits with a high percentage of correlation to the searched term. This high percentage of correlation between the searched term and the website hits is set beforehand by website owners whom know their website product's or service's most intrinsic details and website owners can best describe their product or service with the fewest words and in many ways. These product or service descriptions are linked to the website owner's respective URLs thru the Search Engine Direct Links method and system in an independent Database. This database is searchable the same way the search engine website searches for websites in the search engine database. if a product or service description already defined and linked in the Search Engine Direct Links Database is searched by the user thru a search engine website, when found, all websites linked to that description will be listed in the Search Engine Direct Links as websites result list. These websites have high percentage of correlation to the searched term since these descriptions were created by the same people providing the product or service, just as described above.

### Advantages

Accordingly, several advantages are as follows: to provide website search engines a second and short list with more realistic results and in alignment with what the user is searching. Also, to allow website owners to make their websites stand out among thousands of websites that may or may not offer the same product or service but are competing the same for a place in the search engine result list.

### DRAWING—FIGURES

FIG. 1 shows the flow chart on how the Search Engine Direct Link Database is updated with a new website product or service description to create a new SEDL link.

FIG. 2 shows how a Search Engine Direct Link is search and call up to be displayed when a user searches thru a search engine website.

FIG. 3 shows a search engine website page with an example of a term searched and results, from the search engine website and the Search Engine Direct Links method and system.

### DRAWINGS—REFERENCE NUMERALS

10 Search Engine Direct Links process website page to register and to log on
12 SEDL website window interface to SEDL Database to view, change or create new SEDLs
14 Decision to check if selecting to create new SEDL
16 SEDL website page process to enter SEDL elements to create new SEDL
18 Decision to check if all information is entered and valid
20 SEDL Database and process to update same
30 Search Engine Website field for user to enter term to search
32 Decision to start the search
34 Process to search the SEDL Database
36 Decision to display SEDL links if term found in SEDL Database
38 Process to show SEDL links result from SEDL Database
40 Process to not show SEDL links result when none found
50 a Search Engine Website
60 the Search Engine Website input field
70 a search term “tires” entered in the input field
80 the Search Engine Website list result
90 the Search Engine Direct Links websites list result

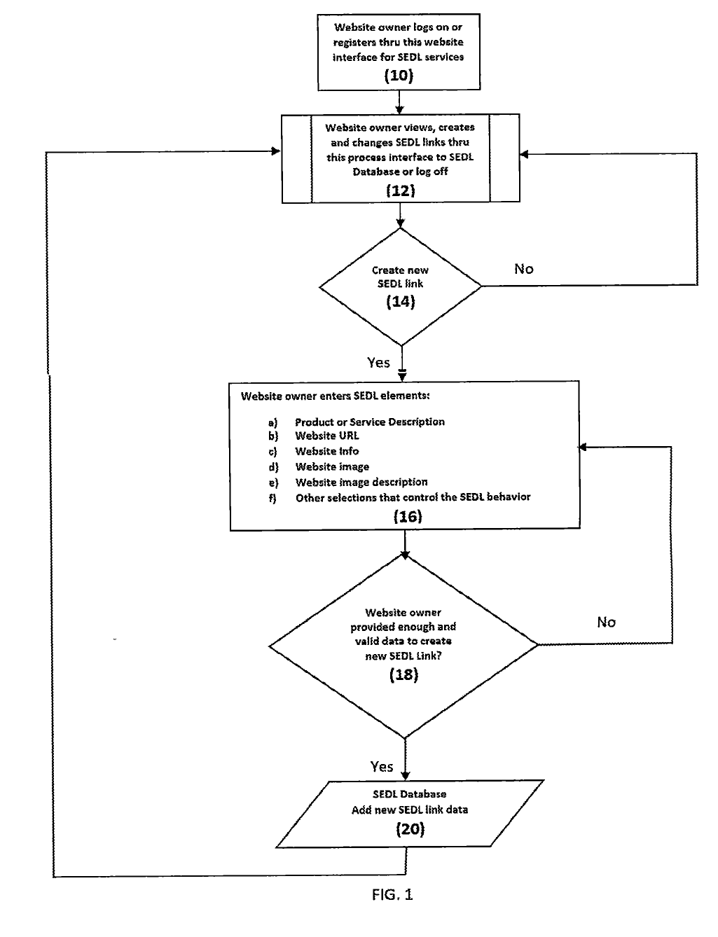

### DETAILED DESCRIPTION—FIGS. 1, 2 and 3

One part of this process is the Search Engine Direct Link Database, it is managed and updated as shown in FIG. 1 flow chart. This database is on the same network as the search engine website and it is available for access by providing the correct credentials. This database various parts identical to the search engine website database and it operates in the same way; it is searchable, it is indexed and it contains data and key elements to control what is displayed, when to display it and how to display it. This SEDL Database can also be accessed via a website page interface 10 (FIG. 1) by website owners or webmasters that have an account and have acquired SEDL services. The SEDL Database has a website window predefined process 12 (FIG. 1) to view, update, create new SEDLs or to log off among other things. It has a process 14 (FIG. 1) that checks if a request to create a new SEDL is selected. It has an interface 16 (FIG. 1) to accept new SEDL elements necessary to create a new SEDL. It has a process 18 (FIG. 1) to automatically validate those elements and a update SEDL Database 20 (FIG. 1) with the new SEDL and to return the website window 12 (FIG. 1) to repeat an action or to log off, whatever is the need of the user.

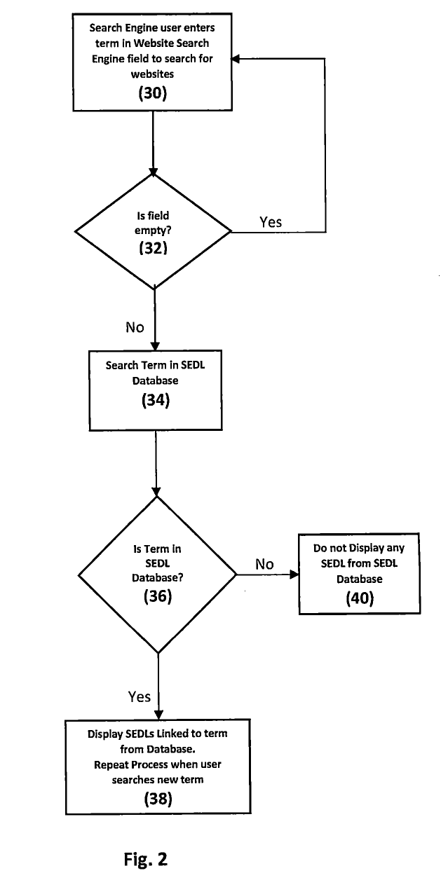

Another part of this method is the operation as shown in the flow chart from FIG. 2. The first process 30 (FIG. 2) is for the search engine website to accept terms to search. This process 30 (FIG. 2) is also available for the SEDL method and system. The flow chart has a decision checker 32 (FIG. 2) to start the process or do nothing. It also has a process 34 (FIG. 2) to search the SEDL database. Another block in this flow chart is a decision checker 36 (FIG. 2) to display or not to display, and a process 40 (FIG. 2) to display a specific message if not a single SEDL was found and a second process 38 (FIG. 2) to display results if one or more SEDLs were found.

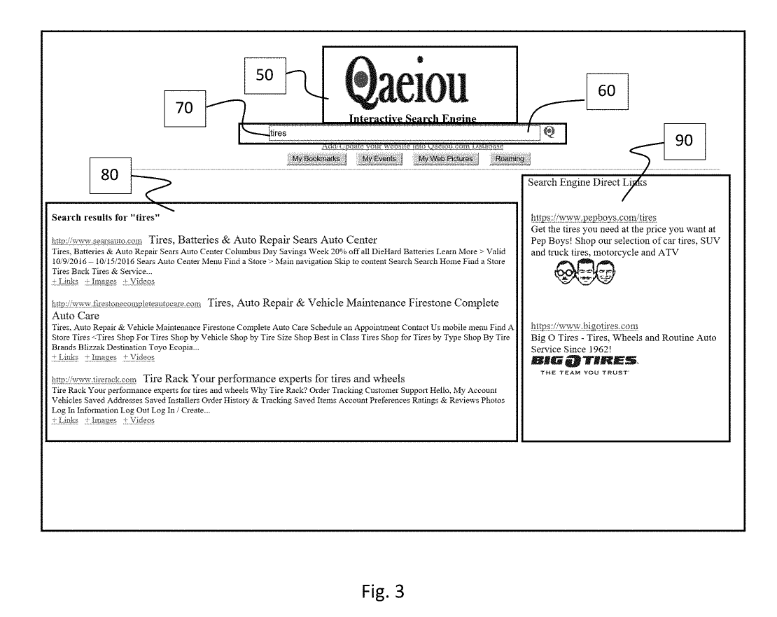

A working example of the Search Engine Direct Links method and system is shown in FIG. 3. The following blocks can be easily identified; starting with the search engine website 50 (FIG. 3) follow by the input field 60 (FIG. 3). There is also an input term 70 (FIG. 3) entered. And finally, two blocks, each one displaying a unique list based on the term input “tires”. One block is the search engine website result list 80 (FIG. 3) that displays websites found thru the search engine website, another block is the SEDL links result list 90 (FIG. 3) and displays SEDL links found thru the SEDL method and system.

### Operations—FIGS. 1, 2 and 3

The process of accessing the Search Engine Direct Links database is via a website interface 10 (FIG. 1) by providing a user account and a password. In this website page a new user can register and gain credentials to log on. Once a user has an account and logs in into the SEDL services, the user can start creating SEDL links by making the selection in predefined process 12 (FIG. 1). This predefined process is an interface to the SEDL Database and the user can view or change any existing SEDL links under the current log on account. If the user has the need to create new SEDL link, the user can make the selection thru process 14 (FIG. 1) that will take the user to the input page process 16 (FIG. 1). In this process the user must make selections for the desire behavior of the new SEDL link and must provide key elements: Product or service description, website URL, website information, website image URL link and website image description, to build a successful SEDL link. When all required information and key elements are validated and verified by process 18 (FIG. 1), SEDL Database 20 (FIG. 1) is updated with new SEDL link. Once the database is update the flow is to send the user to predefined process 12 (FIG. 1) for the user to make a new selection or to log off.

The manner of operating the SEDL method and system is for this method and system to be incorporated with a website search engine and use the same input field 30 (FIG. 2) to search both the search engine database and the SEDL Database. The website search engine will operate like any other search engine. The focus on this application is to demonstrate the operation as shown in FIG. 2 flow chart, specifically for the SEDL method and system. Once the input field 30 (FIG. 2) has a parameter to search, we will call this a “term”, the SEDL method will acknowledge this thru flowchart decision 12 (FIG. 2) and moves on to start searching the term against the SEDL Database as indicated by process 34 (FIG. 2). If the term is found, the flowchart decision 36 (FIG. 2) will activate either process 38 (FIG. 2) to display all SEDLs linked to this term or process 40 (FIG. 2) to display a specific message based on the findings. Every time there is a new term searched, the operation of this method and system will repeat.

The Search Engine Direct Links method and system operates as sown in FIG. 3 in the following manner: A website search engine and the Search Engine Direct Link method and system are coupled to use the same input term to do their search thru their own databases. The search engine database contains millions of websites information. The SEDL Database may have thousands of websites products or services descriptions linked to their own respective websites within the database. Both are searched independently by each method. Both will produce independent result but based on the same input. In this example, FIG. 3, search engine website 50 (FIG. 3), the input field 60 (FIG. 3) has the term “tires” 70 (FIG. 3) entered by a user to search the internet for “tires”. The search engine searches its database and returns a list of websites 80 (FIG. 3) found in its database. The SEDL method and system searches its database and returns a list of websites 90 (FIG. 3) found in its database. The process is repeated every time a new term is searched.

### Advantages

Search Engine Direct Links method and system helps search engine users find the product or service in a more efficient way by creating a direct link between what users are searching and what websites truly have to offer. And a search engine website user gets a more manageable websites list with a precise result to the term searched. These precise results are set by website owners and webmasters and even by business owners willing to support their websites and businesses by producing better search engine result to their customers thru the SEDL method. These businesses owners have active and fully supported websites and are willing to acquire the SEDL services to make their website businesses stand out among thousands and thousands of websites found during a regular search engine search.

I claim:

1. A Search Engine Direct Links method and system for assigning and displaying in a communication network system thru a search engine website that uses a database with a direct link description linked to websites, website titles and website images and images description where the search engine searching terms match the direct link description and call up linked websites, linked websites titles and linked websites images and images descriptions to be displayed in a specific search engine website section and where the websites in the Search Engine Direct Links database are URLs and the websites titles are text and images are images from URLs and the descriptions are text whereas all is stored in a database and the database has other fields like the link number and owner account of the link and dates when link was created and dates when link was activated and dates when link will expire and status of the link and with these fields the Search Engine Direct Links are controlled and maintained.

2. The method of claim 1, wherein the database is called Search Engine Direct Links database and it is a separate database from the main search engine database.

3. The method of claim 1, wherein assigning means linking a direct link description to a website, website title and website image and image description and it is entered by the website owner or business representative thru a customer account link within the same Search Engine Direct Link database.

4. The method of claim 1, wherein displaying means calling the matched searched term against the direct links description from the Search Engine Direct Links database and displaying the website, website title, website image and image description in a network communication system search engine webpage section assigned to display direct links results.

5. The method of claim 1, wherein direct links descriptions are one, two, three, four and up to five words describing the product or service provided by the business or website owner is linked to websites, websites titles, website images and website images descriptions in the Search Engine Direct Links database.

6. The method of claim 1, wherein a communication network system is a network communication established between two or more electronic devices thru a communication system.

7. The method of claim 6, wherein electronics devices can be any device with electronic capability to access a network communication system.

8. The method of claim 1, wherein a search engine website is running in a network communication system where a user enters a search term and the search engine website accesses the Search Engine Direct Links database and calls to display websites, websites titles and websites images all linked to the user search term thru the direct links descriptions.
